(19) United States
(12) Patent Application Publication
(10) Pub. No.: US 2006/0002775 A1
(43) Pub. Date: Jan. 5, 2006

(54) Parallel-serial bevel and hypoid gear generating machine

(76) Inventors: Zhang-Hua Fong, Minxiong Shiang (TW); Pei-Yu Wang, Puyan Shiang (TW); Hong-Guang Ding, Yangmei Town (TW); Cheng-Kuo Sung, Min-Hsiung (TW); Ching-Huan Tseng, Hsinchu (TW)

Correspondence Address: RABIN & Berdo, PC, 1101 14TH STREET, NW, SUITE 500, WASHINGTON, DC, 20005, US

(21) Appl. No.: 10/879,270

(22) Filed: Jun. 30, 2004

(51) Int. Cl. B23F 9/10

(52) U.S. Cl. 409/27; 409/30

(57) ABSTRACT

A bevel gear generating machine includes a main work platform, an X-axis work platform movably connected to the main work platform in an X-axis, a Y-axis work platform movably connected to the X-axis work platform, a rotary device coupled to the Y-axis work platform and having a workpiece seat and a power source to drive the workpiece seat to pivot relative to the Y-axis work platform, and a parallel device, wherein each linkage has a first end connected to the tool seat via a universal joint to allow the workpiece seat to pivot in two different directions and a second end coupled to a corresponding one of the sliding seats to allow the sliding seats to pivot, the driving motor is connected to the sliding seats to drive the sliding seats to move in the Z-axis.

### BACKGROUND OF THE INVENTION

1. Field of the Invention

The present invention relates to a parallel-serial bevel and hypoid gear generating machine.

2. Description of Related Art

Typical bevel and hypoid gear generating machines include a machine base and separate supports resting on the base for mounting a work gear and a rotating tool. The tool support is arranged to carry a rotary tool in the machine plane, which represents an imaginary gear positioned to mesh with the work gear. A machine cradle is journaled in the tool support so that its axis of rotation represents the axis of the imaginary gear. A rotary tool, having stock removing surfaces that represent one teeth in the imaginary gear, is supported on the front face of the cradle. In particular, the rotary tool is mounted on a tool spindle, which is journaled in a tilt mechanism carried by the cradle. The tilt mechanism is used to adjust the angular position of the rotary tool axis with respect to the cradle axis so that the stock removing surfaces of the tool are oriented to appropriately represent the position of gear teeth on the theoretical generating gear.

The work gear support generally includes means for adjusting the mounting position of the work gear so that the work gear will fit into mesh with the imaginary gear represented by the tool support. The work gear is journaled for rotation in the work support and means for rotating the work gear interconnect with means for rotating the machine cradle so that the work gear may be rotated in a timed relationship with the rotation of the cradle. Tooth sides are generated in the work gear by imparting a relative rolling motion between the tool and work gear as though the work gear were in mesh with another gear member (i.e. the theoretical generating gear) having an axis of rotation coincident with the machine cradle axis and mating tooth surfaces represented by the stock removing surfaces of the tool. The rotary tool may be arranged to represent a single tooth in a generating gear or may include a number of stock removing surfaces, which are specially positioned on the tool body for timed rotation with the work gear to represent a generating gear with a plurality of teeth. For purposes of additional background, it may be appreciated that for a number of years, advances in the computer and electronics industry have been routinely applied to machine tools. In fact, most state-of-the-art machine tools now include some sort of computer control. Such machines are referred to in the industry as computer numerically controlled (CNC) machines. It is well known, for example to use computers to control both machine operation and setup. Computers also enable a series of machines performing separate functions to work together in a system to perform many different operations on work pieces and to produce a number of different work pieces without requiring substantial manual intervention.

Although conventional bevel and hypoid type gear generating machines have been recently fitted with computer controls, mainly for monitoring and controlling machine operation, much of the set up of these machines still requires manual intervention. For example, U.S. Pat. No. 3,984,746 discloses a “master-slave” servo-system for replacing certain gear trains in a conventional bevel and hypoid gear generating machine which control relative machine motions during use. However, much of the setup of the modified machine still requires substantial manual intervention. Conventional bevel and hypoid gear generating machines require nine or more machine settings for appropriately positioning the tool with respect to the work gear. These settings include: (a) an angular setting of the cradle, (b) three angular settings of the tilt mechanism, (c) a rectilinear feed setting between the tool and work supports, (d) a rectilinear setting of work gear height above the machine base, (e) an angular setting of the work gear axis, and (f) a rectilinear setting of the work gear along its axis. These settings are difficult to make to required accuracy and are time consuming. Most of these settings are accomplished manually because the large number of settings and their often congested locations render computer control of these settings extraordinarily complex and/or prohibitively expensive.

For example, known tool tilt mechanisms on bevel and hypoid gear generating machines are associated with a number of particularly difficult settings. These settings are made to incline and orient the tool axis with respect to the cradle axis so that the stock removing surfaces of the tool are positioned to appropriately represent tooth surfaces of the theoretical generating gear. Three coordinated settings known in the art as “eccentric angle”, “swivel angle”, and “tilt angle” are usually required for this purpose. The tool drive that acts through the tilt mechanism also involves an extraordinary amount of complexity. This drive is required to impart rotation to the tool at variable angular orientations and positions with respect to the cradle axis. Thus, both the complex settings of the tool tilt mechanism and the tool drive at variable orientations take place within the space of the machine cradle that is rotatable. Accordingly, machine cradles tend to be quite large and cumbersome. The diameter of the theoretical generating gear represented by the tool support is also substantially determined by the diameter of the machine cradle. Thus, it may be readily understood that the just-mentioned slides may be used to move a tool axis to the same position otherwise effected by a cradle in non-generating machines. This general concept has also been proposed for bevel and hypoid generating machines in WO 02/066193, JP 62-162417 and JP 11-262816. However, neither of these proposed generating machines suggests any means for inclining the tool axis with respect to their intended representation of the customary cradle axis. In fact, even if a known tool axis tilt mechanism were to be added to either of the proposed machines, the arcuate translation of an inclined tool axis along the rectilinear slides of the proposed machines would not reproduce the rotational motion of the inclined tool axis about the cradle axis of a conventional machine. In other words, translation of an inclined axis about another axis to which it is initially inclined is not the same as rotation of the inclined axis about another axis. Thus, neither of the proposed generating machines disclosed in the patents just referred to above is appropriate for manufacturing the variety of gears traditionally produced by conventional bevel and hypoid generating machines which utilize large machine cradles and complex tilt mechanisms for appropriately positioning and operatively engaging a tool and work gear.

Furthermore, even when generating without any provision for tool axis tilt, neither of the proposed machines appears to account for the change in angular position of the tool about its axis which should accompany their respective translational representations of cradle axis rotation, and the lack of such a change in angular position would undesirably affect the required timed relationship between tool and work rotations during continuous indexing operations.

Another important consideration relating to the generation of longitudinally curved tooth bevel and hypoid gears is the determination of appropriate setup and operating parameters for such machines. Because of the complexity of tooth surfaces formed by conventional bevel and hypoid generators, such tooth surfaces can only be exactly defined geometrically by the machine motions that are used to produce them.

Further, little or no benefit would be derived from the large amount of existing know-how which relates such desired tooth geometry and mating characteristics to conventional machine settings. This is particularly true of “higher order” modifications that are expressed directly in terms of known machine motions or in terms of a theoretical generating gear.

To overcome the shortcomings, the present invention intends to provide an improved bevel gear generating machine to mitigate the aforementioned problems.

### SUMMARY OF THE INVENTION

The primary objective of the invention is to provide an improved bevel gear generating machine. The machine configuration is greatly simplified with respect to bevel gear generating machines of the prior art and is readily adaptable to computer controls for automatically setting up and operating the machine.

The machine of the present invention has more freedom in rotation and minimum accumulated error so as to increase the precision of the machine.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a machine in accordance with the present invention;

FIG. 2 is a perspective view of the machine observed from a different angle;

FIG. 3 is a perspective view of the machine observed from still a different angle;

FIG. 4 is a perspective view of a rotary device of the present invention;

FIG. 5 is a schematic view showing the movement of the rotary device of the present invention;

FIG. 6 is a perspective view of a parallel device of the present invention;

FIG. 7 is a cross-sectional view of the parallel device shown in FIG. 6; and

FIG. 8 is a schematic view showing the movement of the parallel device of the present invention.

### DETAILED DESCRIPTION OF PREFERRED EMBODIMENT

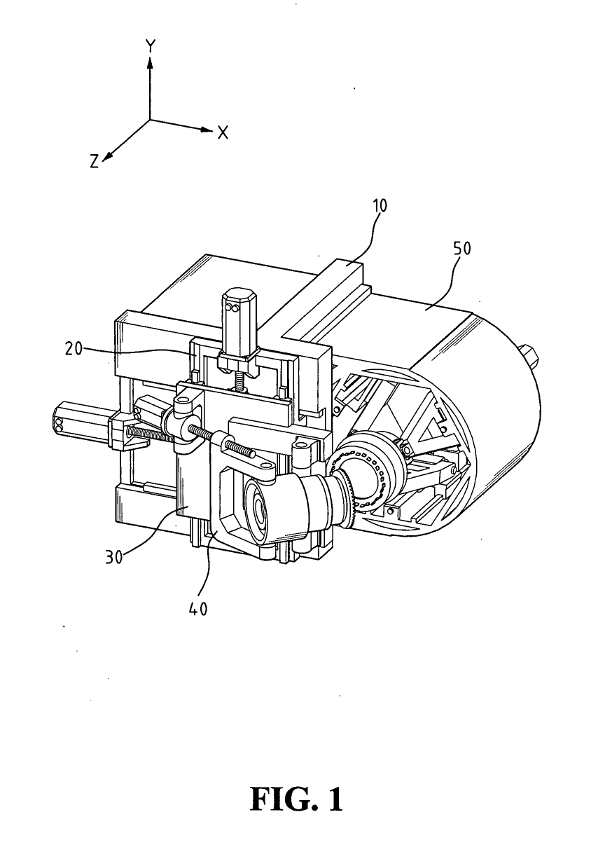

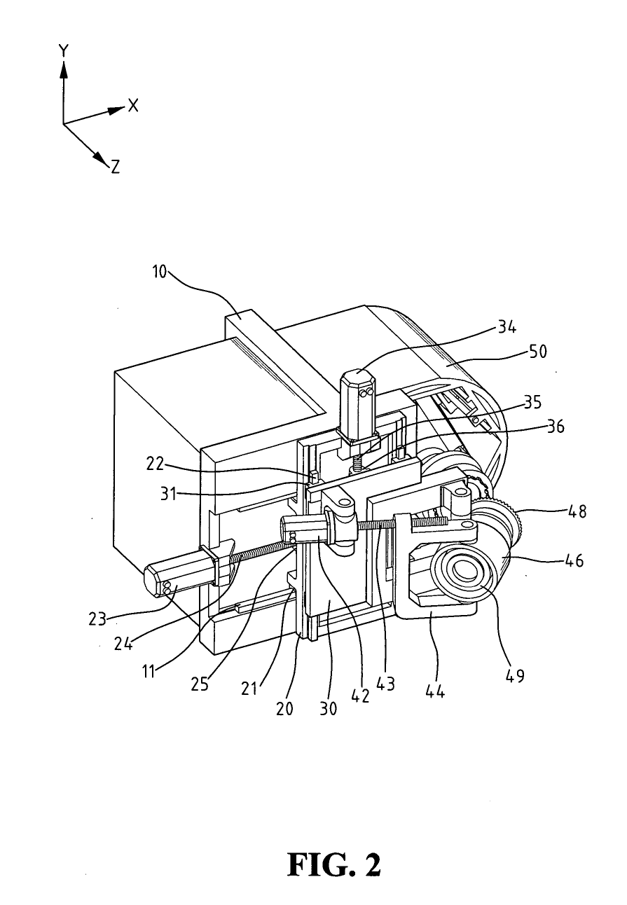

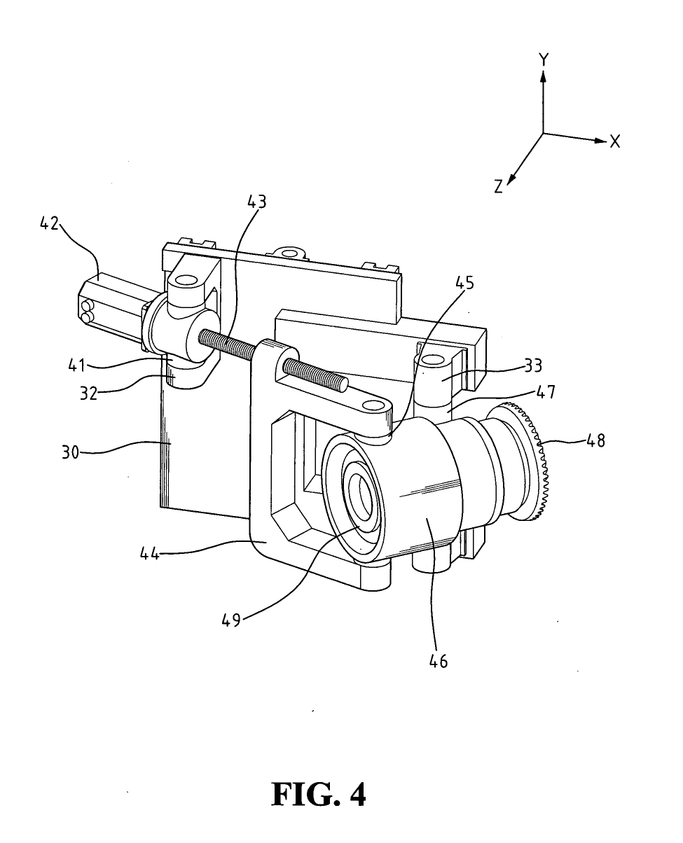

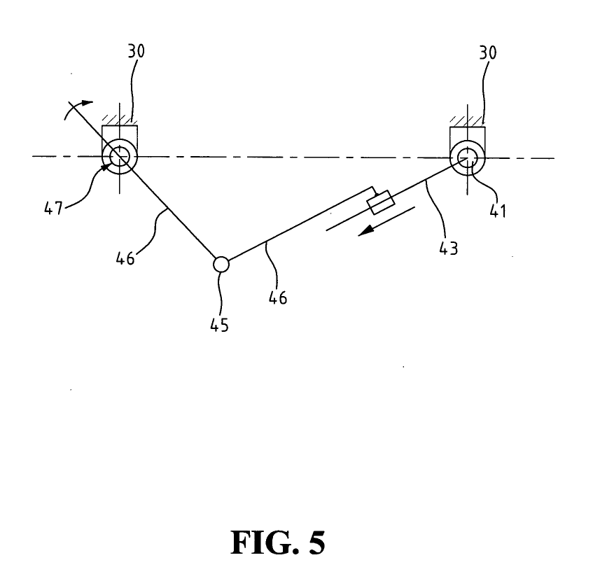

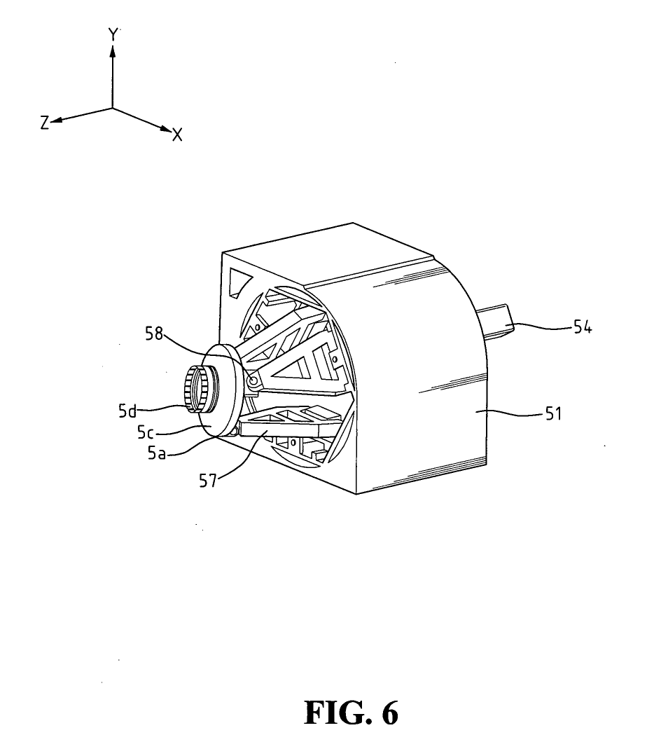

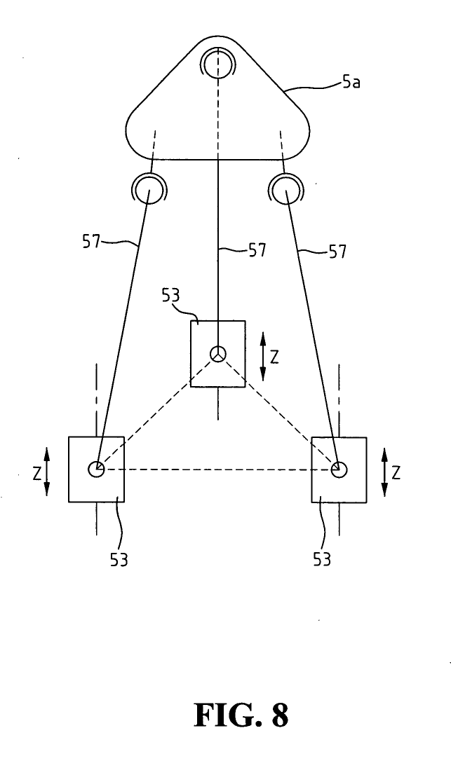

With reference to FIGS. 1-3, a bevel gear generating machine constructed in accordance with the present invention includes a main work platform 10, an X-axis work platform 20, a Y-axis work platform 30, a rotary device 40 (as shown in FIGS. 4 and 5), and a parallel device 50 (as shown in FIGS. 6-8).

The main work platform 10 has a pair of first tracks 11 formed in the X-axis to correspond to a pair of second tracks 21 formed on the X-axis work platform 20 to form a sliding pair to provide the X-axis work platform 20 to slide thereon. The X-axis work platform 20 has a pair of Y-axis third tracks 22 to correspond to a pair of Y-axis fourth tracks 31 formed on the Y-axis work platform 30 to form a sliding pair to allow the Y-axis work platform 30 to slide thereon. The X-axis work platform 20 is driven at a side face 25 thereof by a first threaded bolt 24 in connection with a first motor 23 that is mounted on the main work platform 10. Therefore, when the first threaded bolt 24 is driven by the motor 23, the X-axis work platform 20 is able to move in the X-axis.

The Y-axis work platform 30 is driven at a side face 36 thereof by a second motor 34 mounted on the X-axis work platform 20 via a second threaded bolt 35 such that when the second threaded bolt 35 is driven by the second motor 34, the Y-axis work platform 30 is able to move in the Y-axis. A first bearing seat 32 and a second bearing seat 33 are mounted on the Y-axis work platform 30 (as shown in FIG. 4) to respectively receive therein a first rotary shaft 41 and a second rotary shaft 47. The first rotary shaft 41 is in combination with a drive motor 42, which in turn securely engages with a third threaded bolt 43 parallel to the X-axis. The second rotary shaft 47 is combined with a workpiece seat 46 having therein a rotary motor 49 to rotate a workpiece 48 securely mounted on an end of the workpiece seat 46. A third rotary shaft 45 extends out from opposite sides of the workpiece seat 46 to be coupled with a frame 44 which is threadingly connected to the third threaded bolt 43. The main work platform 10, the X-axis work platform 20 and the Y-axis work platform 30 are connected to each other in series so that the combination of the Y-axis work platform 30, the third threaded bolt 43, the frame 44 and the workpiece seat 46 is able to move in both the X and Y axes. Preferably, the rotary motor 49 is able to connect to the third threaded bolt 43 and rotate the workpiece 48 directly without the workpiece seat 46.

The rotary device 40 is pivotally connected to the first bearing seat 32 via the first rotary shaft 41 and the third threaded bolt 43 is connected to the frame 44 to allow the frame 44 to pivot relative to the Y-axis work platform 30. The frame 44 is pivotally connected to the workpiece seat 46 via the third rotary shaft 45 to allow the workpiece seat 46 to pivot relative to the frame 44. The second rotary shaft 47 is pivotally received in the second bearing seat 33 and connects to the workpiece seat 46. Thus a rotary device 40 is formed. Therefore, when the drive motor 42 is activated to drive the third threaded bolt 43 to rotate, the workpiece 48 received in the workpiece seat 46 is able to pivot to an angle required. In alternating embodiment, the drive motor 42 is able to drive the frame 44 directly and still achieve the same goal, which is shown in FIGS. 4 and 5.

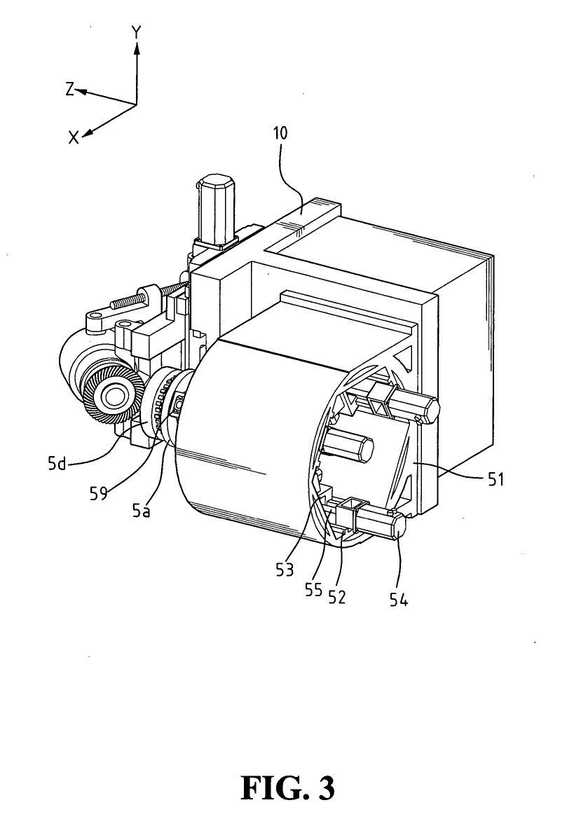

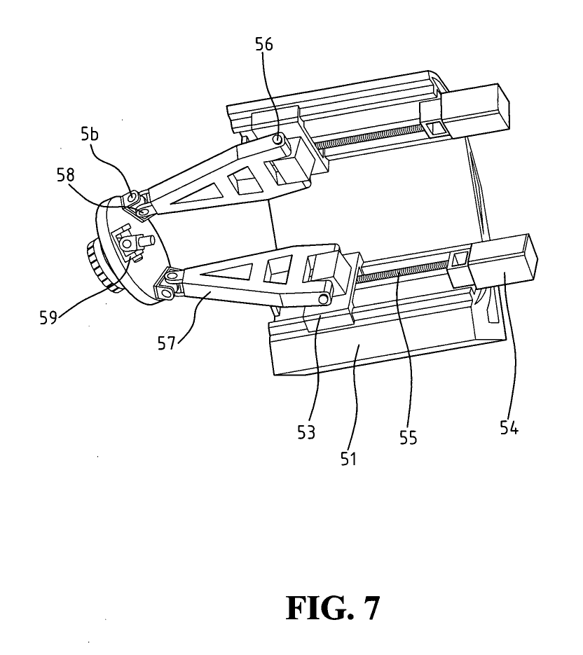

The parallel device 50, as shown in FIGS. 7 an 8, of the present invention is fixed on the main work platform 10 via a casing 51. The casing 51 has three pairs of sliding tracks 52 (shown in FIG. 3), three pairs of sliding seat 53 in corresponding to the sliding tracks 52 and three motors 54 each with a fourth threaded bolt 55 in connection with a corresponding one of the sliding seats 53 such that when each of the motors 54 is activated to drive the fourth threaded bolt 55 to rotate to force the sliding seats 53 to move along the Z-axis, the sliding seats 53 is able to pivot about a first pin 56 connecting the sliding seat 53 to a linkage 57 which in turn connects to a universal joint 59 via a second pin 58. The universal joint 59 is fixed on a tool seat 5a (as shown in FIG. 6) and has a third pin 5b sandwiched between the linkage 57 and the universal joint 59 to allow the universal joint 59 to pivot in two different directions and thus the three sliding seats 53 are able to control the position of the tool seat 5a. The tool seat 5a has a driving motor 5c inside the tool seat 5a to control the rotation of the tool 5d formed on the tool seat 5a.

Another embodiment of the present invention is that the position of the workpiece seat 46 of the rotary device 40 and the tool seat 5a of the parallel device 50 may be switched and thus the tool seat 5a is coupled to the frame 44 and the workpiece seat 46 is connected to the linkages 57 inside the parallel device 50.

From the aforementioned description, it is noted that the rotation angle of the device of the present invention is increased and the accumulated error is decreased in the production of bevel gear, which are the most advantageous aspects of the present invention.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A bevel gear generating machine comprising:
a main work platform;
an X-axis work platform movably connected to the main work platform in an X-axis;
a Y-axis work platform movably connected to the X-axis work platform to allow the Y-axis work platform to move in an Y-axis relative to the X-axis work platform;
a rotary device coupled to the Y-axis work platform and having a workpiece seat and a power source to drive the workpiece seat to pivot relative to the Y-axis work platform; and
a parallel device including a casing, a tool seat, a driving motor, multiple linkages and multiple sliding seats movable relative to the casing in a Z-axis, wherein each linkage has a first end connected to the tool seat via a universal joint to allow the tool seat to pivot in two different directions and a second end coupled to a corresponding one of the sliding seats to allow the sliding seats to pivot, the driving motor is connected to the sliding seats to drive the sliding seats to move in the Z-axis.

2. The machine as claimed in claim 1, wherein the main work platform and the X-axis work platform sandwich a sliding pair to allow the X-axis work platform to move relative to the main work platform.

3. The machine as claimed in claim 2, wherein the main work platform has first tracks formed in the X-axis to correspond to a pair of second tracks 21 formed on the X-axis work platform so as to form the sliding pair.

4. The machine as claimed in claim 1, wherein the main work platform has a first motor with a first threaded bolt in connection with the X-axis work platform such that the first motor is able to drive the first threaded bolt to rotate and thus the X-axis work platform is driven by the first threaded bolt to move in the X-axis.

5. The machine as claimed in claim 2, wherein the main work platform has a first motor with a first threaded bolt in connection with the X-axis work platform such that the first motor is able to drive the first threaded bolt to rotate and thus the X-axis work platform is driven by the first threaded bolt to move in the X-axis.

6. The machine as claimed in claim 3, wherein the main work platform has a first motor with a first threaded bolt in connection with the X-axis work platform such that the first motor is able to drive the first threaded bolt to rotate and thus the X-axis work platform is driven by the first threaded bolt to move in the X-axis.

7. The machine as claimed in claim 1, wherein the X-axis work platform and the Y-axis work platform sandwich a second sliding pair to allow the Y-axis work platform to move in the Y-axis.

8. The machine as claimed in claim 7, wherein the X-axis work platform has a pair of Y-axis third tracks to correspond to a pair of Y-axis fourth tracks formed on the Y-axis work platform to form the second sliding pair.

9. The machine as claimed in claim 1, wherein a second motor is formed on the X-axis work platform and has a second threaded bolt in connection to the Y-axis work platform such that the Y-axis work platform is able to move in the Y-axis.

10. The machine as claimed in claim 7, wherein a second motor is formed on the X-axis work platform and has a second threaded bolt in connection to the Y-axis work platform such that the Y-axis work platform is able to move in the Y-axis.

11. The machine as claimed in claim 8, wherein a second motor is formed on the X-axis work platform and has a second threaded bolt in connection to the Y-axis work platform such that the Y-axis work platform is able to move in the Y-axis.

12. The machine as claimed in claim 1, wherein the rotary device includes a drive motor pivotally mounted on the Y-axis work platform and provided with a third threaded bolt, a frame in connected to a free end of the third threaded bolt and pivotally connected and a workpiece seat to allow the workpiece seat to pivot relative to the Y-axis work platform.

13. The machine as claimed in claim 12, wherein the Y-axis work platform has a first bearing seat with a first rotary shaft to connect to the drive motor and a second bearing seat with a second rotary shaft to pivotally connect the workpiece seat.

14. The machine as claimed in claim 12, wherein the workpiece seat has a rotary motor to rotate the workpiece seat directly.

15. The machine as claimed in claim 13, wherein the workpiece seat has a rotary motor to rotate the workpiece seat directly.

16. The machine as claimed in claim 12, wherein the frame is connected to the third threaded bolt and the workpiece seat.

17. The machine as claimed in claim 1, wherein the parallel device further includes a pin sandwiched between a corresponding linkage and a corresponding sliding seat to allow each sliding seat to pivot.

18. The machine as claimed in claim 15, wherein the parallel device further includes a pin sandwiched between a corresponding linkage and a corresponding sliding seat to allow each sliding seat to pivot.

19. The machine as claimed in claim 16, wherein the parallel device further includes a pin sandwiched between a corresponding linkage and a corresponding sliding seat to allow each sliding seat to pivot.

20. A bevel gear generating machine comprising:
a main work platform;
an X-axis work platform movably connected to the main work platform in an X-axis;
a Y-axis work platform movably connected to the X-axis work platform to allow the Y-axis work platform to move in an Y-axis relative to the X-axis work platform;
a rotary device coupled to the Y-axis work platform and having a workpiece seat and a power source to drive the workpiece seat to pivot relative to the Y-axis work platform; and
a parallel device including a casing, a workpiece seat, a driving motor, multiple linkages and multiple sliding seats movable relative to the casing in a Z-axis, wherein each linkage has a first end connected to the workpiece seat via a universal joint to allow the workpiece seat to pivot in two different directions and a second end coupled to a corresponding one of the sliding seats to allow the sliding seats to pivot, the driving motor is connected to the sliding seats to drive the sliding seats to move in the Z-axis.
